(19) United States
(12) Patent Application Publication
(10) Pub. No.: US 2011/0037453 A1
(43) Pub. Date: Feb. 17, 2011

(54) DETECTOR DEVICE

(75) Inventor: Axel Hulsmann, Freiburg (DE)

Correspondence Address: VOLPE AND KOENIG, P.C., UNITED PLAZA, 30 SOUTH 17TH STREET, PHILADELPHIA, PA, 19103, US

(73) Assignee: Fraunhofer-Gesellschaft zur Forderung der angewandten Forschung E.V., Munchen (DE)

(21) Appl. No.: 12/933,489

(22) PCT Filed: Mar. 17, 2009
(86) PCT No.: PCT/EP09/01999

§ 371 Date: Sep. 20, 2010

(30) Foreign Application Priority Data
Mar. 20, 2008 (DE) 102008015160.2

(51) Int. Cl. H01F 30/12

(52) U.S. Cl. 324/76.75

(57) ABSTRACT

A high-frequency detector device (1) including a detector circuit in which the input gate of the branch line coupler, from which the fundamental wavelength of an input signal is extinguished, is used for decoupling a bias voltage V_{DC} of two Schottky-diodes (4, 5) and by a HF-technique, is closed by a resistance (R₀) of a line impedance (Z₀). Both phase-displaced outputs (8, 9) of the branch line-coupler (7) traverse electrical connection lines (19, 20) to reach two detector diodes (4, 5) and are recombined after the detector diodes (4, 5). The combined signals are guided to the detector output (3) via a downstream path filter (34). A compensation circuit (21) includes, for compensating the temperature drift of the detector diodes (4, 5), at least one additional diode (22, 24) that is structurally identical to the detector diodes (4, 5).

### BACKGROUND

The invention relates to a detector device for high-frequency signals in a frequency range, in particular, an advantageously wide-band, high-frequency-signal detector device or an advantageously wide-band, high-frequency detector, with at least one detector input, at least one detector output, and at least one detector diode, as well as to a method for measuring the power of a high-frequency signal in a frequency band.

In general, high frequency is understood to be frequencies above 3 MHz.

The use of Schottky diodes for microwave power measurement is known.

For example, U.S. Pat. No. 5,394,159 shows a diode detector that is integrated in a strip-conductor antenna, wherein tuning and matching of the detector are achieved by adjusting the geometry of the patch antenna.

Furthermore, from U.S. Pat. No. 4,791,380, a detector circuit for high-frequency signals is known, wherein this detector circuit is formed by a pair of matched diodes and wherein the diodes are deposited on a common substrate that is heated by a feedback circuit reacting to temperature.

From U.S. Pat. No. 4,000,472, an envelope detector is known that has a standard voltage doubler envelope detector whose linear operating range is increased by a quiescent current and in which the voltage bias is stabilized by a temperature-drift compensation.

The higher the frequency of the electromagnetic wave to be detected, the more important good power matching becomes. For this purpose, a diode with a matching network is provided on the input, wherein optimum impedance matching is typically achieved only at a certain frequency, so that, outside of a narrow-band frequency range, a portion of the microwave power is reflected and thus incorrect measurements are produced that can be compensated by a corresponding calibration, but limits the range of use.

From U.S. Pat. No. 4,873,484, a power sensor is known with three switch branches that have a common node in which power measurements in the range of 0 to +30 dBm on a coaxial output and power measurements in the range of −50 dBm to 0 dBm on a different coaxial output are performed. The power sensor thus can be operated in an expanded power range.

From DE 102 95 964 T5, a power detector is known with larger detection range in which a first power detector is attached to a first branch and a second power detector is attached to a second branch, wherein the first and the second power detectors are calibrated for different sub-ranges of a dynamic range.

From US 2006/0160501 A1, a tunable microwave device with an auto-tuning matching circuit is known, wherein a dynamic impedance matching network is designed for determining a mismatch at an input.

From US 2005/0270123 A1, an electronic phase reflector with improved phase-shift properties is known in which two varactor diodes are connected to a ground reference potential.

### SUMMARY

The invention is based on the objective of creating a detector device of the type noted above in which the power matching at the detector input is improved.

This objective is met according to the invention in that the detector input of the detector device is connected electrically to a first input of a branch line coupler, the first detector diode is arranged between a first output of the branch line coupler and the detector output, and a second detector diode is arranged between a second output of the branch line coupler and the detector output. Advantageously, the detector diodes are each arranged in the pass-through direction between the corresponding output of the branch line coupler and the detector output, that is, each with their input connected electrically to the relevant outputs of the branch line coupler and with their outputs connected electrically to the detector output. In general, a branch line coupler is understood to be a four-pole coupler in which, at the input gate, the fundamental wave is blanked out with respect to a preselected frequency. The detector output can have a one-pole or a multiple-pole connection on which the output voltage signals of the diodes are separated or can be tapped in combination. In the invention it is advantageous that the branch line coupler used for the power matching of the detector diodes, which is different from its intended use, produces wide-band power matching. Thus it is possible to use Schottky detectors for wide-band power measurement of electromagnetic radiation with excellent linearity and responsiveness up to the THz range. The invention is suitable, in particular, for use in imaging systems in the range of microwaves to THz waves, for THz spectroscopy, for radar, for radiometry, as well as for power measurement of electromagnetic radiation in general, especially in the microwave, millimeter wave, and sub-millimeter wave range.

While the known devices according to U.S. Pat. No. 4,873,484, DE 102 95 964 T5, US 2006/0160501 A1, and US 2005/0270123 A1 are directed toward the development of an expanded power range, the invention provides an expanded frequency range for power measurements.

The detector device according to the invention thus can be used advantageously for the detection of signals in the frequency range above 1 GHz, for example, in the W band, 75-110 GHz, or above, or in the D band, 110-170 GHz.

One embodiment of the invention can provide that, on the detector output, the sum of the signal on the output side of the first detector diode and the signal on the output side of the second detector diode is provided. This sum is measured on the detector output advantageously as a voltage drop across a high-impedance resistor. In this way, the phase shift of the output signals of the branch line coupling is advantageously used for an additional smoothing and reduction of harmonic waves in the output signal of the detector device. The summation of the two signals can be realized through separate digitization and subsequent addition. One especially simple circuit configuration is produced, however, when the output sides of the first and second detector diodes are connected electrically and guided together to the detector output.

One embodiment of the invention can provide that the frequency range is characterized at least by a center frequency and the arms of the branch line coupler each have a length that equals greater than one eighth and less than half the wavelength of the center frequency of the detector device, in particular, approximately one fourth of the wavelength of the center frequency, wherein deviations from this by ten percent still produce excellent power matching on the detector input. The center frequency is advantageously determined by the arithmetic or geometric mean of the limiting frequencies of the frequency range. Advantageously, the frequency range is a continuous section of the frequency scale.

The wide-band property of the power matching can be increased by mismatching the lengths of the arms of the branch line coupler relative to each other, that is, they deviate from the value of one fourth of the wavelength of the center frequency in different directions and by different amounts.

According to one embodiment of the invention, it can be provided that the arm of the branch line coupler between the first and the second input and/or the arm of the branch line coupler between the first and the second output has/have an impedance value that each equals between half and one and a half times the impedance value of the detector input side, in particular, is approximately equal to this value. Advantageously, both arms, that is, the arm of the input gate and the arm of the output gate have the same impedance value whose value is equal to the impedance of the detector input side. However, for deviations of up to 10% and even up to 20% and more from this value, very good wide-band power-matching properties can still be achieved.

According to one construction of the invention it can be provided that the arm of the branch line coupler between the first input and the first output and/or the arm of the branch line coupler between the second input and the second output has/have an impedance value that equals greater than half the impedance value and less than the impedance value of the detector input side, in particular, approximately 70% of the impedance value of the detector input side. Advantageously, the two mentioned arms are constructed with the same impedance values and/or an impedance value of 1/√2 times the impedance value of the detector input side, wherein deviations of up to 10% and more from this value still produce very good wide-band power matching.

According to one construction of the invention it can be provided that a second input of the branch line coupler is powered electrically by a voltage source, advantageously a direct-voltage source. Thus, the input gate of the coupler on which, on the branch line coupler, the fundamental wave of the input signal is blanked out and that with the characteristic impedance can be terminated is used for coupling the bias voltage of the two detector diodes. Through the supplied bias voltage, the operating point of the detector diodes can be selected advantageously for an optimal operation of the detector device. For feeding a negative bias voltage, the detector diodes are each arranged in the blocking direction between the corresponding output of the branch line coupler and the detector output and can be operated, that is, with their outputs connected electrically to the relevant outputs of the branch line coupler and with their input connected electrically to the detector output.

In each case, the detector diodes are connected with respect to the voltage source in the pass-through direction, that is, with the input toward the positive pole or with the output toward the negative pole, wherein the case of no voltage source for the arrangement of the detector diodes is handled like a case with positive voltage source.

For reducing the reflection on the detector input, it can be provided that, on the second input of the branch line coupler, a terminating resistor is provided whose value is equal to the high-frequency characteristic impedance of the input-side network. Advantageously, this resistor is arranged in series between a direct-voltage source for the bias voltage of the detector diode and the second input of the branch line coupler, but a bias voltage could also not be needed according to the dimensioning of the detector device and according to the range of use. The input-side network is the network on which the detector input is connected. Such an input-side network can comprise, for example, an antenna and/or an amplifier stage. Through the matching resistor on the second input of the branch line coupler, the detector input is terminated for high frequencies with the characteristic resistance.

Improved matching of the detector diodes on the branch line coupler is produced when the electrical connection line between the first output of the branch line coupler and the first detector diode and the electrical connection line between the second output of the branch line coupler and the second detector diode each have an impedance value that is greater than the impedance value of the detector input side and less than twice the impedance value of the detector input side, in particular, equals approximately 1.4 times the impedance value of the detector input side, wherein very good matching properties are also produced for a deviation of up to 10% or even up to 20% from the √2 times the impedance value of the detector input side.

For improving the operating behavior, in particular, for compensating temperature fluctuations, it can be provided that the detector device has a compensation circuit that is powered by the voltage source, the compensation circuit has at least one third diode, the at least one third diode is constructed with the first detector diode and/or with the second detector diode on a common chip, and the third diode is arranged in the pass-through direction between the voltage source and a compensation output. The input of the third diode is thus connected to the voltage-guiding output of the voltage source, while the output of the third diode is connected electrically to the compensation output. Advantageously, this third diode is constructed by itself or together with other diodes, so that the temperature behavior of the first and second detector diode is reproduced individually or together. The third diode therefore can be used as a compensation diode.

An especially effective compensation of temperature-related fluctuations of the properties of the first and second detector diodes is produced when the compensation circuit has a fourth diode, when the fourth diode is connected parallel to the third diode, and when the first, second, third, and fourth diodes are structurally identical and constructed on a common chip. In this way it is advantageously achieved that the third and fourth diodes are at the same temperature level as the first and second detector diodes, wherein the compensation circuit exhibits a temperature behavior that is identical to the temperature behavior of the first and second detector diodes. A structurally identical construction of the diodes is understood to be, in particular, a construction that is equal in surface area and/or geometry and/or material for the conductive junction areas in the diodes. The fourth diode thus can also be used like the third diode as a compensation diode.

Additional smoothing of the output signal of the detector device is produced when a low-pass filter is arranged between the first and second detector diode and the detector output. Advantageously, the low-pass filter comprises a resistor whose resistance value is greater by at least two orders of magnitude than the resistance value of the terminating resistor on the second input of the branch line coupler and that connected between the output of the detector diodes and ground. In this way, it is advantageously achieved that the terminating resistor provided for the input-side termination has, on the second input of the branch line coupler, a negligible influence on the detector diodes, and an output voltage signal can be tapped across the resistor of the low-pass filter.

For a construction of the invention it can be provided that a low-pass filter is arranged between the third and/or the fourth diode and the compensation output, wherein this low-pass filter is constructed equal to the low-pass filter on the detector output. In particular, this low-pass filter has similar components in the same circuit arrangement as the low-pass filter on the detector output, wherein the parameters of the components of both low-pass filters are equivalent. In this way it is advantageously achieved that the compensation circuit can reproduce the temperature behavior of the detector diodes even better. For further improvement of the reproduction in the compensation circuit, it can be provided that a resistor is arranged on the input of the compensation circuit, wherein the resistance value of this resistor is equal to the resistance value of the terminating resistor on the second input of the branch line coupler.

Especially advantageous detector properties are produced in the invention when the detector diodes are constructed as Schottky diodes. In this way it is possible to use the excellent linearity and responsiveness of the Schottky diodes for the wide-band power measurement of electromagnetic radiation up to the THz range.

The integration of Schottky diodes is simplified by the use of Schottky diodes as gate fingers of a field-effect transistor (FET).

According to one construction of the invention, it could be provided that an evaluation unit is provided with which the difference of the voltage signals on the detector output and on the compensation output can be calculated and with which the power of the input signal applied on the detector input can be determined. Advantageously, such an evaluation unit is constructed as a differential amplifier whose inputs are connected to the detector output and the compensation output.

An especially compact construction is produced when the differential amplifier is constructed integrated, for example, on a chip.

Because the concept concerns circuit elements that can be easily realized in monolithically integrated microwave, millimeter wave, and sub-millimeter wave circuits (so-called MMICs), complete receiver systems could be realized as a single-chip solution. The arms of the branch line coupler and/or the electrical connection lines can be realized, for example, by micro-strip conductors or coplanar waveguides whose geometry produces the necessary impedance values. In this way, the spatial and weight requirements of complete systems is reduced considerably. In particular, such a detector MMIC could be integrated from low-noise amplifiers or LNAs and Schottky detectors and thus could compensate for the reduced detection quality of the optionally present FET Schottky contacts. The video output voltage that is applied on the detector output and that advantageously has the most linear possible dependency on the high-frequency input power is measured, for example, by a low-pass filter that is integrated either with the overall circuit from casing switch, input LNA, and Schottky detector or from the input resistance and the input capacitance of an oscilloscope or is realized in another way.

Through the integration possibility, the described circuit concept has excellent suitability for imaging radiometry or radar systems in the millimeter or sub-millimeter frequency range, but also for THz waves. Such systems are needed, for example, for safety-related personnel airlocks or in space travel for remote sensing.

With the invention of a detector device, advantageously a method can be performed for power determination of an electromagnetic signal in a frequency band, wherein the signal is fed into the detector input of a detector device according to the invention, the center frequency of the detector device lies within the frequency band, and the voltage on the detector output of the detector device is determined as a measure for the applied signal power. Advantageously, in the method, the difference of the voltage on the detector output of the detector device and the voltage on a compensation output of the detector device is determined as a measure for the applied signal power. The compensation output of the detector device here provides a signal that reproduces the temperature drift of the detector diodes provided for the power determination of the fed signal.

### BRIEF DESCRIPTION OF THE DRAWINGS

The invention will now be explained in more detail with reference to embodiments, but is not limited to these embodiments. Additional embodiments could be formed by combination with features from the subordinate claims and/or by the addition of expert knowledge.

Shown are:

FIG. 1 is a block circuit diagram of a detector device according to the invention,

FIG. 2 is a block circuit diagram of another detector device according to the invention with a compensation circuit,

FIG. 3 shows the reflection of the fed signal as a function of the frequency in a detector device according to the invention,

FIG. 4 shows the reflection of the fed signal on the detector input in a detector device according to the invention in a Smith chart,

FIG. 5 shows the dependency of the voltage signal on the detector output on the frequency of the fed signal,

FIG. 6 is a plot of the voltage difference from FIG. 5,

FIG. 7 shows the dependency of the output signals on the fed power,

FIG. 8 shows the reflection of the fed signal on the detector input as a function of the fed power, and

FIG. 9 shows the dependency of the reflected signal on the detector input on the fed signal power in a Smith chart.

### DETAILED DESCRIPTION OF THE PREFERRED EMBODIMENTS

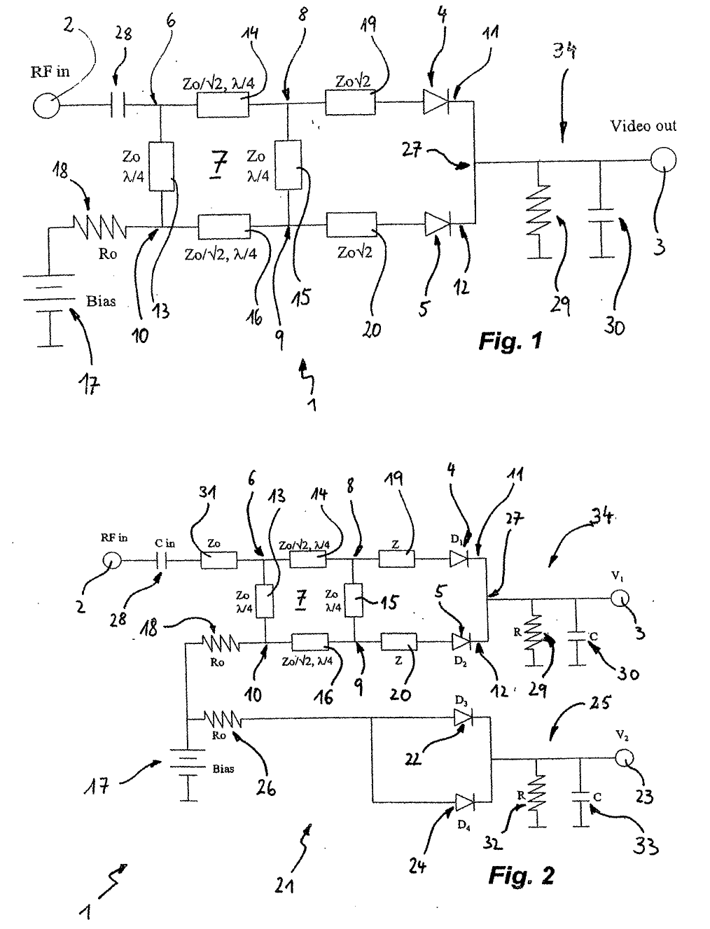

FIG. 1 shows a detector device 1 for electrical or electromagnetic high-frequency signals in a frequency range, called input signals below, wherein the high-frequency signal is coupled into a detector input 2. The detector input 1 has a detector output 3 on which an output signal “Video Out” is applied whose voltage level varies with the power of the coupled input signal “RFin”.

For generating this output signal, the detector device 1 has a first detector diode 4, or, for short, first diode 4, and a second detector diode 5, or, for short, second diode 5, which are both constructed as Schottky diodes.

For matching the detector device 1 to a network not shown in more detail in FIG. 1 and connected to the detector input 2 and by which the input signals are coupled into the detector device 1, a first input 6 of a branch line coupler 7 is connected electrically to the detector input 2 and the first detector diode 4 is connected electrically with its input side to the first output 8 of the branch line coupler 7 and the second detector diode 5 is connected with its input side to the second output 9 of the branch line coupler 7. On the outputs 8 and 9 of the branch line coupler 7 on which the input signals phase-shifted relative to each other by 90° and divided approximately in half in their power, a detector diode 4 and 5 are connected, respectively, each of which generates a signal as a function of the incoming power. A deviation from the half division can be accepted for the function of the circuit, especially for the use of Schottky diodes. First detector diode 4 and second detector diode 5 are each arranged in the pass-through direction between the first output 8 or the second output 9 and the detector output 3.

Thus, on the detector output 3, the sum of the signal on the output side 11 of the first detector diode 4 and the signal on the output side 12 of the second detector diode 5 is provided and can be measured as a voltage drop across the resistor 29. For this purpose, the output sides 11 and 12 of the first and second detector diodes 4 and 5 are connected at a node 27 and guided together to the detector output 3.

The detector device 1 is constructed for power measurement of a high-frequency input signal within a frequency range, wherein the frequency range is characterized by a center frequency. The branch line coupler 7 is constructed as a four-pole circuit, wherein the poles 6, 8, 9, and 10 are each connected as shown by arms 13, 14, 15, and 16. These arms 13, 14, 15, and 16 each have a length that equals one fourth of the wavelength of the center frequency.

In order to achieve a widest possible wide-band coupling of the branch line coupler 7 to the detector input 2, the arms 13 and 15 that connect the inputs 6 and 10 and the outputs 8 and 9, respectively, are each constructed so that they have an impedance value that is equal to the impedance value of the detector input side, that is, the impedance value of the input-side network. In the embodiment according to FIG. 1, this impedance value Z₀ is selected at 50Ω. The arms 14 and 16 that each connect an input 6 and 10 to an output 8 and 9 of the branch line coupler 7, respectively, are mismatched, in contrast, by the factor 1/√2 from the impedance Z₀ of the input-side network. These arms 14 and 16 are therefore constructed so that they have an impedance value that equals, rounded, 0.7071-times the impedance Z₀ of the input-side network.

By optimizing the deviation of the values specified in FIG. 1, a higher wide-band property of the matching can be achieved, wherein advantageously the arm 13 remains constructed equivalent to the arm 15 and the arm 14 remains constructed equivalent to the arm 16.

For adjusting the operating point of the diodes 4 and 5, a voltage source 17 is connected to the second input 10 of the branch line coupler 7 on which the first fundamental wave is ideally blanked out at the center frequency of the input signal due to the length configuration of the arms 13, 14, 15, and 16, wherein this voltage source is connected with its other terminal to ground. This voltage source 17 feeds a voltage V_{DC} into the second input 10 of the branch line coupler 7.

For an HF-correct termination of the input-side network, between the voltage-guiding terminal of the voltage source 17 and the second input 10 of the branch line coupler there is also a terminating resistor 18. This terminating resistor 18 has a resistance value R₀ that is equal to the high-frequency characteristic impedance or its real-value limit for high frequencies of the input-side network.

For matching the detector diodes 4 and 5 of the detector device 1, the electrical connection lines between the detector diodes 4 and 5 and the outputs 8 and 9 of the branch line coupler 7 are constructed so that in this case they each have an impedance value that has √2 times, that is, rounded, 1.414 times the impedance value Z₀ of the input-side network.

For compensating for a temperature drift in the detector diodes 4 and 5 in the operation of the detector device 1, according to the embodiment according to FIG. 2, a compensation circuit 21 is also provided that has two diodes 22 and 24 that are connected to each other in parallel and are connected in the pass-through direction between the voltage source 17 and a compensation output 23. The diodes 4, 5, 22, and 24 have identical constructions and are arranged on a common chip. In this way it is achieved that the diodes 22 and 24 follow temperature fluctuations of the detector diodes 4 and 5.

For the embodiments according to FIG. 1 and FIG. 2, the signals applied on the output sides 11 and 12 of the detector diodes 4 and 5 and phase-shifted by 90° relative to each other due to the length dimensions of the arms 13, 14, 15, and 16 of the branch line coupler 7 are combined at a node 27, wherein smoothing of the signal is produced. Additional smoothing of the signal is produced by a low-pass filter 34 that is connected in front of the detector output 3 and has a capacitor 30 and a resistor 29 that are each connected with their free terminals to ground.

For the embodiment according to FIG. 2, the compensation circuit 21 likewise has a low-pass filter 25 that is connected in front of the compensation output 23 and comprises a capacitor 33 and a resistor 32, wherein the capacitance value C of the capacitor 33 is equal to the capacitance value of the capacitor 30 and the resistance value R of the resistor 32 is equal to the resistance value of the resistor 29, wherein a temperature drift on the diodes 22 and 24 causes in the same way on the compensation output 23 a deviation of the voltage signal V₂ like a temperature drift of the diodes 4 and 5 with respect to the voltage signal V₁ on the detector output 3. In addition, the compensation circuit has, on its input, an ohmic resistor 26 whose resistance value R₀ is equal to the resistance value of the terminating resistor 18.

For separating the direct-voltage level V_{DC} that is provided by the voltage source 17 and represents a bias voltage for the diodes 4 and 5 or 22 and 24, in the embodiments according to FIGS. 1 and 2, an isolating capacitor 28 is provided on the detector input, wherein the capacitance value of this capacitor is given by Cᵢₙ.

In addition, between the isolating capacitor 28 and the first input 6 of the branch line coupler 7, the circuit according to FIG. 2 has an impedance 31 whose impedance value Z₀ is selected equal to the impedance value of the input-side network.

The dimensioning of the circuits according to the embodiments, especially the dimensioning of the impedance line elements, can be matched through known optimization algorithms to the desired detection frequency, that is, the center frequency, detection bandwidth, detection sensitivity, and detection linearity.

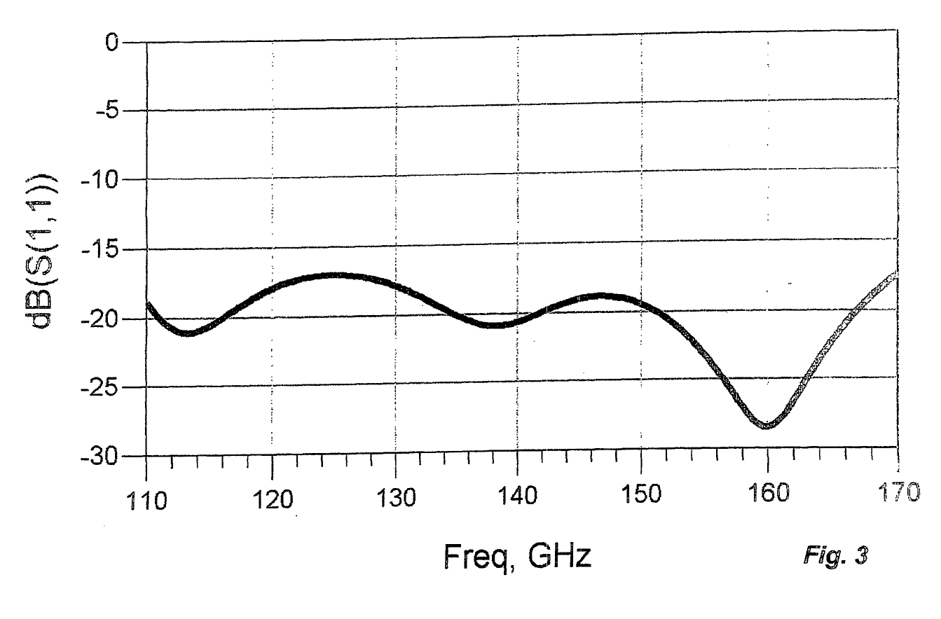

For demonstrating the novel, advantageous properties of the circuit according to the invention, this matching was performed, for example, for a circuit according to FIG. 2, such that the detector device 1 is suitable on the D-band, that is, the frequency range between 110 GHz and 170 GHz, wherein the center frequency equals the arithmetic mean of the edge frequencies, that is, 140 GHz. After optimization, the following values were produced: Cᵢₙ=87 fF, Z₀=50Ω, impedance value of the arms 13 and 15 each 50Ω, impedance value of the arms 14 and 16 each 30Ω, impedance value of the electrical connection lines 19 and 20 each 70Ω, R=1 MΩ, C=14 pF, R₀=37Ω, V_{DZ}=0.6 V, length of the arms 13 and 15=200 μm, length of the arms 14 and 16=96 μm, length of the electrical connection lines 19 and 20=160 μm. In particular, the length and the impedance value of the impedance 31 in FIG. 2 are determined by the simulation software used for calculating FIGS. 3 to 8.

FIGS. 3 to 8 show the properties of the detector device 1 according to FIG. 2 dimensioned in this way.

FIG. 3 shows the input matching as a function of the coupled high frequency at a coupled power of −20 dBm, wherein 0 dBm corresponds to a power of 1 mW. The magnitude of the signal S(1, 1) reflected on the input 2 is shown in relation to the coupled signal. It is clearly obvious that the reflected signal is reduced by approximately 20 dB relative to the input signal in the frequency range shown overall. For example, the attenuation equals, at 130 GHz, −17.904 dB and, at 150 GHz, −19.444 dB. Outside of the shown range, the attenuation returns to 0 dB, thus the input signal is reflected.

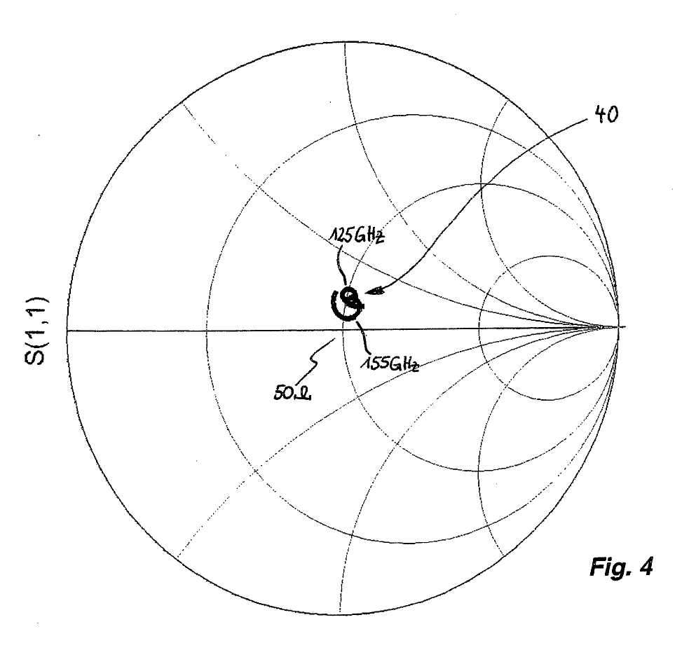

FIG. 4 shows the variability of the complex attenuation factor S(1, 1) of the reflected input signal (40) as a function of the frequency in a Smith chart that is obtained by a Möbius transformation from the corresponding complex half-plane. The representation is related to the impedance value 50Ω of the input-side network. Obviously, the magnitude and phase of the attenuation factor vary in the total frequency range only slightly on the order of magnitude of at most 15%. The following values were produced, for example, at 125 GHz, an impedance of 50.172+j 14.234Ω and an attenuation factor of 0.141 with a phase of 81.220°; at a frequency of 140 GHz, that is, the center frequency, an impedance of 50.925+j 9.377Ω, and an attenuation factor of 0.093 with a phase of 79.061°; at a frequency of 155 GHz, an impedance of 54.866+j 5.479Ω and an attenuation factor of 0.070 with a phase of 45.402°.

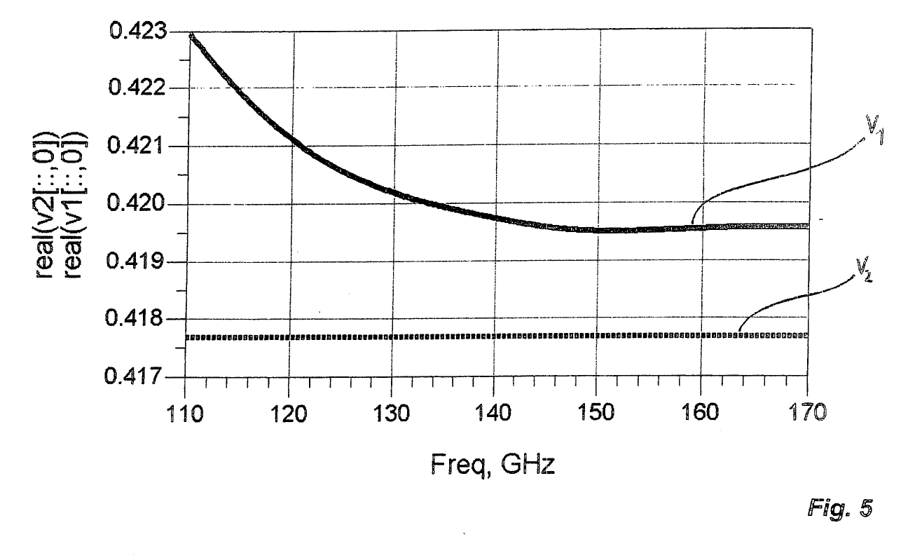

FIG. 5 shows the profile of the output voltage signal V₁ applied on the detector output 3 or the compensation signal V₂ applied on the compensation output in the total frequency range of the D-band at a coupled power Pᵢₙ of −20 dBm, wherein the numerical values are to be read on the ordinate in volts.

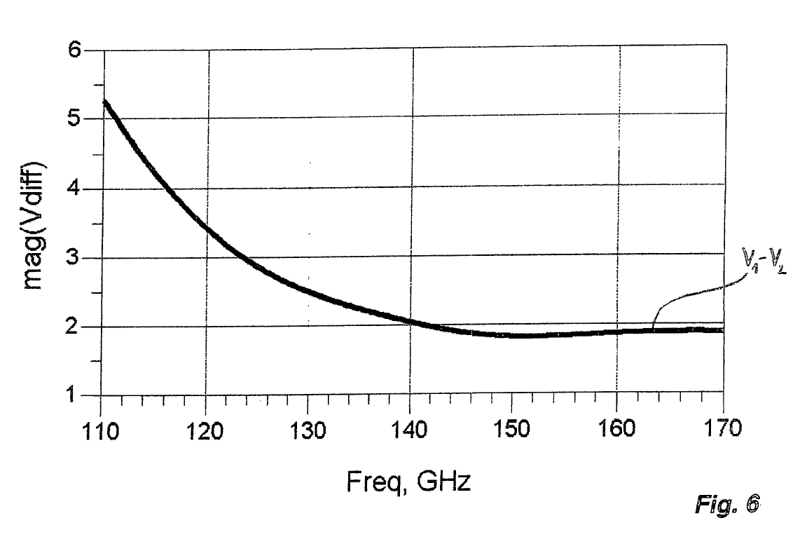

FIG. 6 shows the dependency of the difference signal Vᵢ-V₂ at a coupled power of −20 dBm on the frequency of the coupled input signal. As is clear from the diagram, the difference signal V₁-V₂ above the center frequency 140 GHz is constant to a good approximation, that is, independent of the frequency of the input signal, wherein the difference voltage is to be read on the ordinate in millivolts.

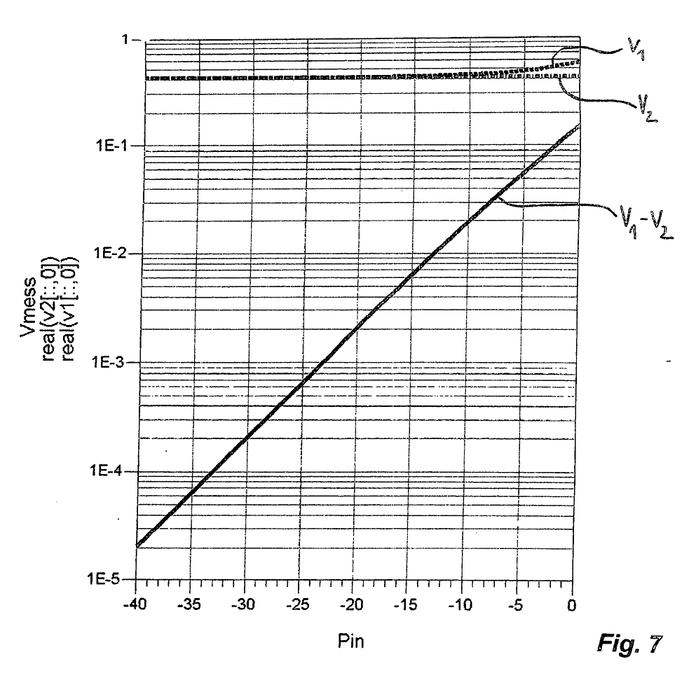

FIG. 7 shows the dependency of the voltages V₁ and V₂ on the coupled power Pᵢₙ of the input signal at 140 GHz in a log-log plot. The voltage signal V₂ is clearly independent of the coupled power, because the diodes 22 and 24 do not detect this input signal, while the signal V₁ is very definitely dependent on the coupled power Pᵢₙ. In the log plot, the dependency of the difference signal V₁-V₂ on the power of the input signal Pᵢₙ can be approximated very well by a straight line. The difference voltage is measured, e.g., with an A/D converter and calculated digitally or subtracted in analog and evaluated with an A/D converter. The A/D converter and analog or digital computer can be slow in comparison with the detected high-frequency signals and advantageously can be produced using silicon technology.

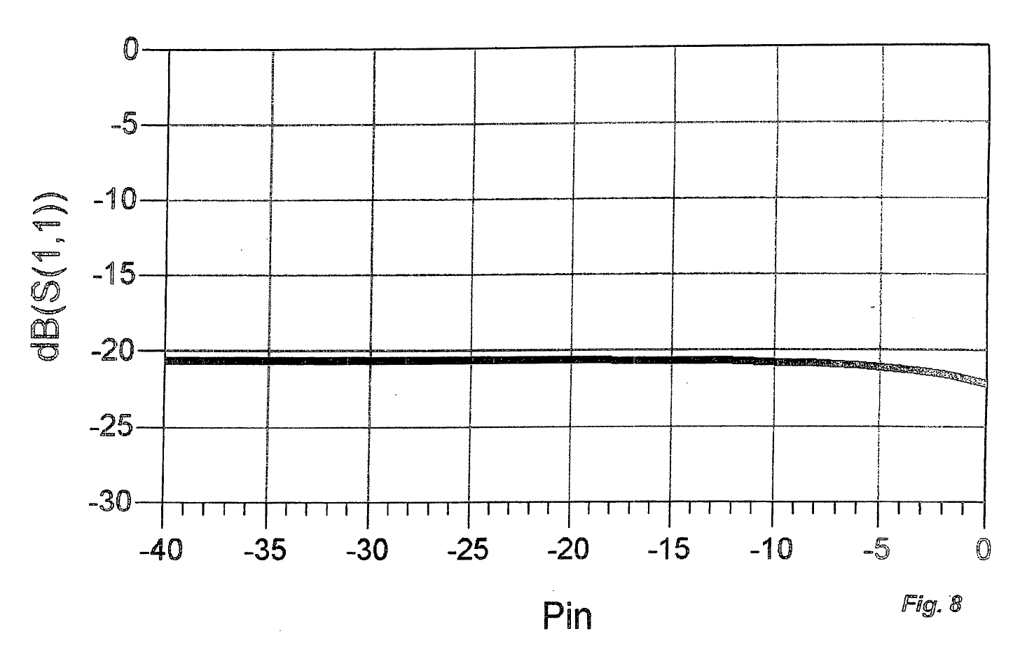

FIG. 8 shows the dependency of the attenuation factor S (1, 1) of the reflected input signal as a function of the coupled power Pᵢₙ of the input signal at the center frequency 140 GHz. Here it is clear that the attenuation in the total power range between 0 and −40 dBm is continuously greater than −20 dB.

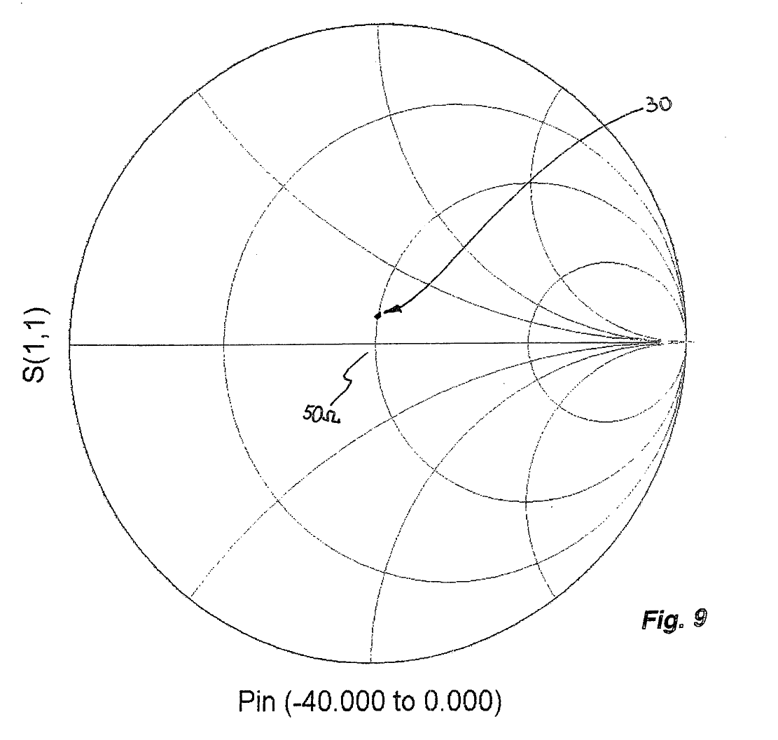

FIG. 9 shows the variation (30) of the attenuation factor S (1, 1) with the coupled power Pᵢₙ in a Smith chart that is referenced, in turn, to the impedance of the input-side network of 50Ω at the center frequency 140 GHz. As the chart shows, no variation of the attenuation factor S (1, 1) can be detected in the illustrated power range at the center frequency.

The invention further relates to a high-frequency detector device with a detector circuit in which the input gate of the branch line coupler on which the fundamental wave of an input signal is blanked out is used for coupling a bias voltage V_{DC} of two Schottky diodes 4 and 5 and is terminated with HF technology with the resistor R₀ of the characteristic impedance Z₀. The two phase-shifted outputs 8 and 9 of the branch line coupler 7 go via matching lines 19 and 20 to two detector diodes 4 and 5 and are combined again behind the diodes. The combined signals are guided by means of a downstream low-pass filter 34 to the detector output 3. A compensation circuit 21 has, for compensating the temperature drift of the detector diodes 4 and 5, at least one additional diode 22, 24 that is structurally identical to the detector diodes 4 and 5. The matching lines 19, 20 are offset relative to the impedance value Z₀, in order to cause a partial reflection of the power signal on the outputs 8 and 9, wherein this reflection leads to the described attenuation of the signal S(1, 1) on the input 6.

1. Detector device (1) for wide-band power measurement for high-frequency signals in a frequency range comprising at least one detector input (2), at least one detector output (3), a first detector diode (4), and a second detector diode (5), the detector input (2) is connected electrically to a first input (6) of a branch line coupler (7), the first detector diode (4) is arranged between a first output (8) of the branch line coupler (7) and the detector output (3), the second detector diode (5) is arranged between a second output (9) of the branch line coupler (7) and the detector output (3), and output sides (11, 12) of the first detector diode (4) and the second detector diode (5) are connected electrically and guided together to the detector output (3).

2. Detector device (1) according to claim 1, wherein a sum of a signal on the output side (11) of the first detector diode (4) and a signal on the output side (12) of the second detector diode (5) is provided to the detector output (3).

3. Detector device (1) according to claim 2, wherein the frequency range includes a center frequency and the branch line coupler (7) has arms, wherein the arms (13, 14, 15, 16) of the branch line coupler (7) each have a length that equals greater than one eighth and less than half a wavelength of the center frequency of the detector device (1).

4. Detector device (1) according to claim 3, wherein at least one of the arms (13) of the branch line coupler (7) between the first input (6) and a second input (10) or one of the arms (15) of the branch line coupler (7) between the first output (8) and the second output (9) has an impedance value that each equals between half and one-and-a-half times an impedance value of the detector input side (2).

5. Detector device (1) according to claim 4, wherein at least one of the arms (14) of the branch line coupler (7) between the first input (6) and the first output (8) or one of the arms (16) of the branch line coupler (7) between the second input (10) and the second output (9) has an impedance value that equals greater than half an impedance value and less than an impedance value of the detector input side (2).

6. Detector device (1) according to claim 4, wherein the second input (10) of the branch line coupler (7) is powered electrically by a voltage source (17).

7. Detector device (1) according to claim 6, wherein the detector diodes (4, 5) are connected in a pass-through direction with reference to the voltage source (17).

8. Detector device (1) according to claim 1, wherein a terminating resistor (18) is provided on the second input (10) of the branch line coupler (7), between the voltage source (17) and the second input (10) of the branch line coupler (7), and a resistance value of a terminating resistor (18) is equal to a high-frequency characteristic impedance of a network provided on the detector input (2).

9. Detector device (1) according to claim 1, wherein at least an electrical connection line (19) between the first output (8) of the branch line coupler (7) and the first detector diode (4) or an electrical connection line (20) between the second output (9) of the branch line coupler (7) and the second detector diode (5) each has an impedance value that is greater than half the impedance value of the detector input side (2) and less than twice the impedance value of the detector input side (2).

10. Detector device (1) according to claim 1, wherein a compensation circuit (21) is powered by the voltage source (17), the compensation circuit (21) has at least one third diode (22), the at least one third diode (21) is constructed with at least one of the first detector diode (4) or with the second detector diode (5) on a common chip, and the third diode (22) is arranged in the pass-through direction with reference to the voltage source (17) between the voltage source (17) and a compensation output (23).

11. Detector device (1) according to claim 10, wherein the compensation circuit (21) has a fourth diode (24), the fourth diode (24) is connected parallel to the third diode (22), and the first (4), second (5), third (22), and fourth (24) diodes are structurally identical and constructed on a common chip.

12. Detector device (1) according to claim 11, wherein a low-pass filter (34) is arranged between the first detector diode (4) and second detector diode (5) and the detector output (3).

13. Detector device (1) according to claim 12, wherein a low-pass filter (25) that is constructed identical to the low-pass filter (34) on the detector output (3) is arranged between at least one of the third diode (22) or the fourth diode (24) and the compensation output (23).

14. Detector device (1) according to claim 13, wherein a resistor (26) is arranged at an input of the compensation circuit (21), wherein a resistance value of the resistor is equal to a resistance value of a terminating resistor (18) on the second input (10) of the branch line coupler (7).

15. Detector device (1) according to claim 11, wherein the diodes (4, 5, 22, 24) are constructed as Schottky diodes.

16. Detector device (1) according to claim 11, wherein the diodes (4, 5, 22, 24) are each constructed as gate fingers of a field-effect transistor.

17. Detector device (1) according to claim 1, wherein an evaluation unit is provided with which a difference of voltage signals (V₁, V₂) on the detector output (3) and on the compensation output (23) can be calculated and with which a power (Pᵢₙ) of the input signal applied to the detector input (2) can be determined from a calculated difference (V₁−V₂).

18. Method for power measurement of a high-frequency signal in a frequency band, the signal is fed into the detector input (2) of a detector device (1) according to claim 1, wherein, a center frequency of the detector device (1) lies within the frequency band, and a voltage (V₁, V₁-V₂) at the detector output (3) of the detector device (1) is determined as a measure for an applied signal power (Pᵢₙ).

19. Method for power measurement of a high-frequency signal in a frequency band, the signal is fed into the detector input (2) of a detector device (1) according to claim 11, wherein, a center frequency of the detector device (1) lies within the frequency band, and a difference (V₁−V₂) of a voltage (V₁) at the detector output (3) of the detector device (1) and a voltage (V₂) on the compensation output (23) of the detector device (1) is determined as a measure for an applied signal power (Pᵢₙ).
